(19) United States
(12) Patent Application Publication
(10) Pub. No.: US 2017/0279779 A1
(43) Pub. Date: Sep. 28, 2017

(54) COMMUNICATION DEVICE, COMMUNICATION SYSTEM, AND COMMUNICATION METHOD

(71) Applicant: RENESAS ELECTRONICS CORPORATION, Tokyo (JP)

(72) Inventor: Daisuke AKITA, Tokyo (JP)

(21) Appl. No.: 15/468,443

(22) Filed: Mar. 24, 2017

(30) Foreign Application Priority Data
Mar. 28, 2016 (JP) 2016-063431

(51) Int. Cl. H04L 29/06; G06F 17/30

(52) U.S. Cl. CPC H04L 63/0428; G06F 17/30952

(57) ABSTRACT

A communication device includes: an encryption unit configured to encrypt a stream into encrypted data using a common key; a communication unit configured to transmit the encrypted data encrypted using the common key to a communication device; a common key update unit configured to update, after an update timing of the common key is reached, the common key using an unencrypted stream of the encrypted data started to be transmitted after the update timing; and a control unit configured to control the encryption unit so that the encryption unit does not start encryption of the stream and control the communication unit so that the communication unit does not start transmission of the encrypted data, in a case where a time when the stream to be transmitted to the communication unit is generated is within a predetermined period before and after the update timing.

### CROSS-REFERENCE TO RELATED APPLICATIONS

This application is based upon and claims the benefit of priority from Japanese patent application No. 2016-063431, filed on Mar. 28, 2016, the disclosure of which is incorporated herein in its entirety by reference.

### BACKGROUND

The present invention relates to a communication device, and can be suitably used for, for example, a communication device configured to perform communication by common key cryptography.

Ethernet (Registered Trademark) AVB (Audio Video Bridging) is a communication standard for an onboard network that is compatible with Ethernet (Registered Trademark) which is widely used as a local area network (LAN) for personal computers (PCs) and consumer products.

Ethernet (Registered Trademark) AVB is extremely efficient because it can utilize the knowledge, technology, and development equipment related to Ethernet (Registered Trademark). On the other hand, Ethernet (Registered Trademark) AVB enables every user to easily refer to data using a PC or the like, and easily transmit the data. Accordingly, it is more important than ever to solidify the security of communication.

As a related art for performing communication between communication devices safely, for example, Japanese Unexamined Patent Application Publication No. 2012-147341 discloses a technique in which communication devices communicate with each other by common key cryptography and update a common key to a new common key at a predetermined timing. Specifically, in Japanese Unexamined Patent Application Publication No. 2012-147341, each of a first device and a second device includes a fixed key table storing a plurality of pieces of fixed key data including index information. The first device selects fixed key data from the filed key table, generates common key data by a predetermined operation process, and transmits the index information included in the selected fixed key data to the second device. The second device acquires, from the fixed key table, the fixed key data corresponding to the index information received from the first device, and generates common key data by the predetermined operation.

### SUMMARY

However, the technique disclosed in Japanese Unexamined Patent Application Publication No. 2012-147341 described above has a problem that since the index information related to the common key is transmitted onto a communication path, data may be decrypted based on the index information, which lowers the security level of the communication.

Other problems to be solved by and novel features of the present invention will become apparent from the following description and the accompanying drawings.

According to one embodiment, after a common key update timing is reached, a communication device updates a common key by using an unencrypted stream of encrypted data that starts to be transmitted after the update timing. Further, when a stream is generated and within a predetermined period before and after the update timing, the communication device does not start encryption of the stream and transmission of the encrypted data.

According to the one embodiment, it is possible to contribute to solving the above-mentioned problem.

### BRIEF DESCRIPTION OF THE DRAWINGS

The above and other aspects, advantages and features will be more apparent from the following description of certain embodiments taken in conjunction with the accompanying drawings, in which:

FIG. 1 is a diagram for explaining a problem that occurs when there is a stream boundary in a time lag between update timings of communication devices;

FIG. 2 is a diagram for explaining a configuration in which a predetermined period before and after a common key update timing is set as a period in which the transmission of a stream is not started according to each embodiment;

FIG. 3 is a diagram showing a configuration example of a communication system according to a first embodiment;

FIG. 4 is a block diagram showing a block configuration example of a transmission device according to first, second, and fourth embodiments;

FIG. 5 is a diagram showing an example of a fixed key table TB according to the first to fourth embodiments;

FIG. 6 is a block diagram showing a block configuration example of a reception device according to the first, second, and fourth embodiments;

FIG. 7A is a flowchart for explaining an example of a communication method performed by the communication system according to the first embodiment;

FIG. 7B is a flowchart for explaining an example of the communication method performed by the communication system according to the first embodiment;

FIG. 8 is a diagram showing a configuration example of a communication system according to the second embodiment;

FIG. 9A is a flowchart for explaining an example of a communication method performed by the communication system according to the second embodiment;

FIG. 9B is a flowchart for explaining an example of the communication method performed by the communication system according to the second embodiment;

FIG. 10 is a diagram showing a configuration example of a communication system according to the third embodiment;

FIG. 11 is a block diagram showing a block configuration example of a slave unit according to the third embodiment;

FIG. 12 is a block diagram showing a block configuration example of a master unit according to the third embodiment;

FIG. 13A is a flowchart for explaining an example of a communication method performed by the communication system according to the third embodiment;

FIG. 13B is a flowchart for explaining an example of the communication method performed by the communication system according to the third embodiment;

FIG. 13C is a flowchart for explaining an example of the communication method performed by the communication system according to the third embodiment;

FIG. 14 is a flowchart showing an example of processes of common key update determinations 1 and 2 shown in FIG. 13C;

FIG. 15 is a diagram showing a configuration example of a communication system according to the fourth embodiment; and

FIG. 16 is a conceptual block diagram showing a block configuration example of the communication system according to the first to fourth embodiments.

### DETAILED DESCRIPTION

Embodiments will be described below with reference to the drawings. For clarity of explanation, the following description and the drawings are abbreviated and simplified as appropriate. The elements illustrated in the drawings as functional blocks for performing various processes can be implemented hardwarewise by a central processing unit (CPU), a memory, and other circuits, and softwarewise by a program loaded into a memory or the like. Accordingly, it is understood by those skilled in the art that these functional blocks can be implemented in various forms including, but not limited to, hardware alone, software alone, and a combination of hardware and software. Note that in the drawings, the same elements are denoted by the same reference numerals, and a repeated description is omitted as needed.

The program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g. magneto-optical disks), CD-ROM (Compact Disc Read Only Memory), CD-R (Compact Disc Recordable), CD-R/W (Compact Disc Rewritable), and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line, such as electric wires and optical fibers, or a wireless communication line.

### Outline of Each Embodiment

First, the outline of each embodiment to be described later will be described.

In each embodiment, each communication device performs communication of a stream by common key cryptography, and updates a common key to a new common key at a predetermined update timing. In this regard, each embodiment of the present invention is similar to Japanese Unexamined Patent Application Publication No. 2012-147341. In each embodiment, however, unlike in Japanese Unexamined Patent Application Publication No. 2012-147341, the communication device updates the common key by using a stream which starts to be transmitted or received after an update timing. Accordingly, unlike in Japanese Unexamined Patent Application Publication No. 2012-147341, the information related to the common key (index information in Japanese Unexamined Patent Application Publication No. 2012-147341) is not transmitted onto the communication path between communication devices, so that the security level of communication can be increased as compared with Japanese Unexamined Patent Application Publication No. 2012-147341.

However, a time lag may occur between the communication devices that perform communication of a stream. When there is a stream boundary between an update timing in one of the communication devices and an update timing in the other one of the communication devices, there is a possibility that different streams may be used for the communication devices to update the common key. This problem will be described below.

According to the time synchronization function of Ethernet (Registered Trademark) AVB, one of the communication devices that perform communication of a stream according to Ethernet (Registered Trademark) AVB serves as a Grand Master, and the other one of the communication devices serves as a Slave. The Slave corrects the time so that the time lag with respect to the Grand Master falls within an error range of ±1 μs. Thus, a time lag up to 1 μs is generated between the Grand Master and the Slave.

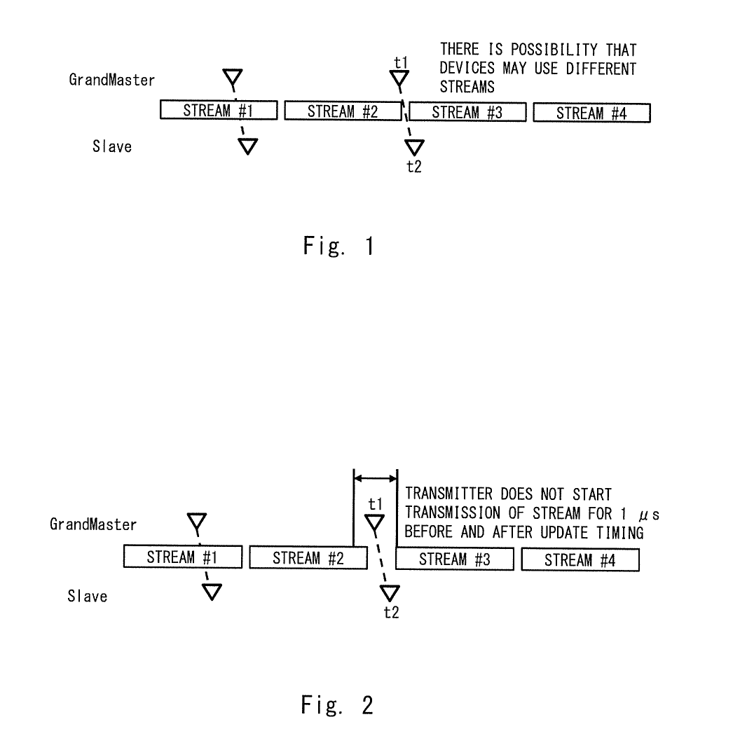

In FIG. 1, an inverted triangle represents a key update timing of a common key in each of the Grand Master and the Slave, and a time lag up to 1 μs is generated between the key update timings of the common key. Further, there is a stream boundary in the time lag between a key update timing t1 in the Grand Master in a key update timing t2 in the Slave.

For example, assuming that the Grand Master is the transmission side and the Slave is the reception side, the stream that starts to be transmitted by the Grand Master after the key update timing t1 is a stream #3. Accordingly, the Grand Master updates the common key by using the stream #3. The stream that starts to be received by the Slave after the key update timing is not the stream #3, which has already started to be received, but is a stream #4. Accordingly, the Slave updates the common key by using the stream #4. Thus, the stream used for the Grand Master to update the common key is different from that used for the Slave to update the common key.

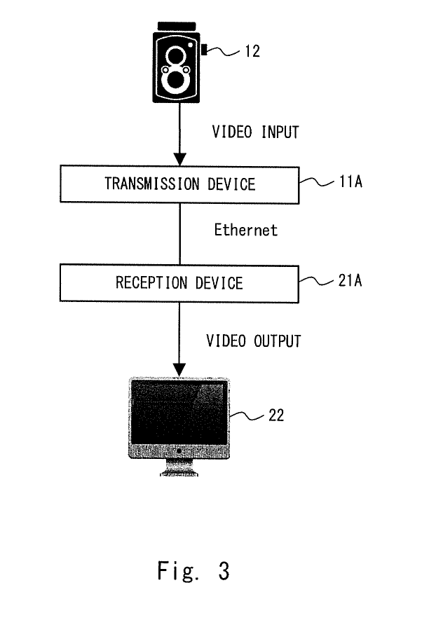

To avoid this, in each embodiment, as shown in FIG. 2, the transmission-side communication device (Grand Master in this example) sets a period of 1 μs before and after the key update timing as a transmission stop period in which the transmission of a stream is not started. Thus, the stream that starts to be transmitted by the Grand Master after the key update timing t1 corresponds to the stream #3, and the stream that starts to be received by the Slave after the key update timing t2 also corresponds to the stream #3. Accordingly, the same stream can be used for the Grand Master and the Slave to update the common key.

Note that the examples shown in FIGS. 1 and 2 are examples in which two communication devices perform one-to-one communication. However, three or more communication devices may perform one-to-multipoint communication or multipoint-to-multipoint communication. In this case, one of the three or more communication devices is used as the Grand Master, and the other communication devices are used as the Slaves. The Slaves correct time so that a time lag with respect to the Grand Master falls within an error range of ±1 μs. Accordingly, when three or more communication devices are included in the communication system, a time lag up to 2 μs is generated between the Slaves. Therefore, when three or more communication devices are included in the communication system, the transmission-side communication device may set the period of 2 μs before and after the update timing as the transmission stop period in which the transmission of a stream is not started.

### First Embodiment

### Configuration of First Embodiment

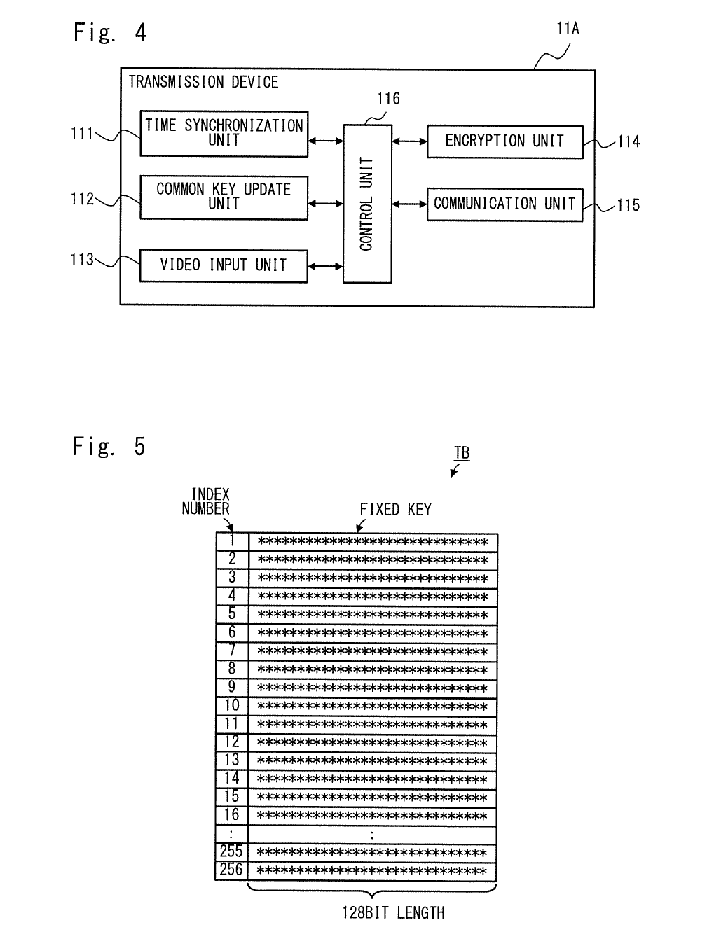

FIG. 3 shows a configuration example of a communication system according to a first embodiment. As shown in FIG. 3, the communication system according to the first embodiment has a configuration in which one transmission device 11A and one reception device 21A perform one-to-one communication. The communication system according to the first embodiment includes one transmission device 11A, one reception device 21A, one camera 12, and one display 22. The one transmission device 11A and the one reception device 21A are directly connected to each other. The transmission device 11A is an example of a communication device and the reception device 21A is an example of a first other communication device.

The transmission device 11A inputs (receives) a video from a camera image obtained from the camera 12, and transmits, to the reception device 21A, encrypted video data obtained by encrypting a video stream. The reception device 21A decrypts the encrypted video data received from the transmission device 11A into a video stream, and outputs the video to the display 22. The transmission device 11A and the reception device 21A perform time synchronization according to the time synchronization function of the Ethernet (Registered Trademark) AVB. The Slave is configured to correct time so that a time lag with respect to the Grand Master falls within an error range of ±1 μs. Assume herein that the reception device 21A is selected as the Grand Master and the transmission device 11A is selected as the Slave.

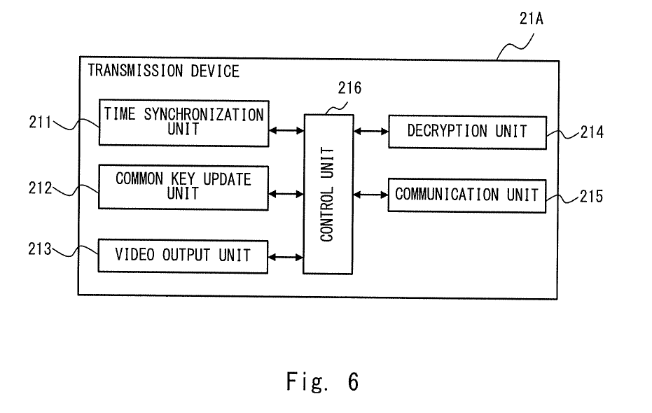

FIG. 4 is a block configuration example of the transmission device 11A according to the first embodiment. As shown in FIG. 4, the transmission device 11A according to the first embodiment includes a time synchronization unit 111, a common key update unit 112, a video input unit 113, an encryption unit 114, a communication unit 115, and a control unit 116.

The time synchronization unit 111 performs time synchronization with the reception device 21A according to the time synchronization function of Ethernet (Registered Trademark) AVB. In the first embodiment, since the reception device 21A is selected as the Grand Master, the time synchronization unit 111 corrects time so that a time lag with respect to the reception device 21A falls within an error range of ±1 μs.

The video input unit 113 inputs (receives) a video from the camera image obtained from the camera 12.

The encryption unit 114 encrypts the video stream inputted (received) by the video input unit 113 into encrypted video data using a common key.

The communication unit 115 communicates with the reception device 21A. For example, the communication unit 115 transmits, to the reception device 21A, the encrypted video data encrypted by the encryption unit 114.

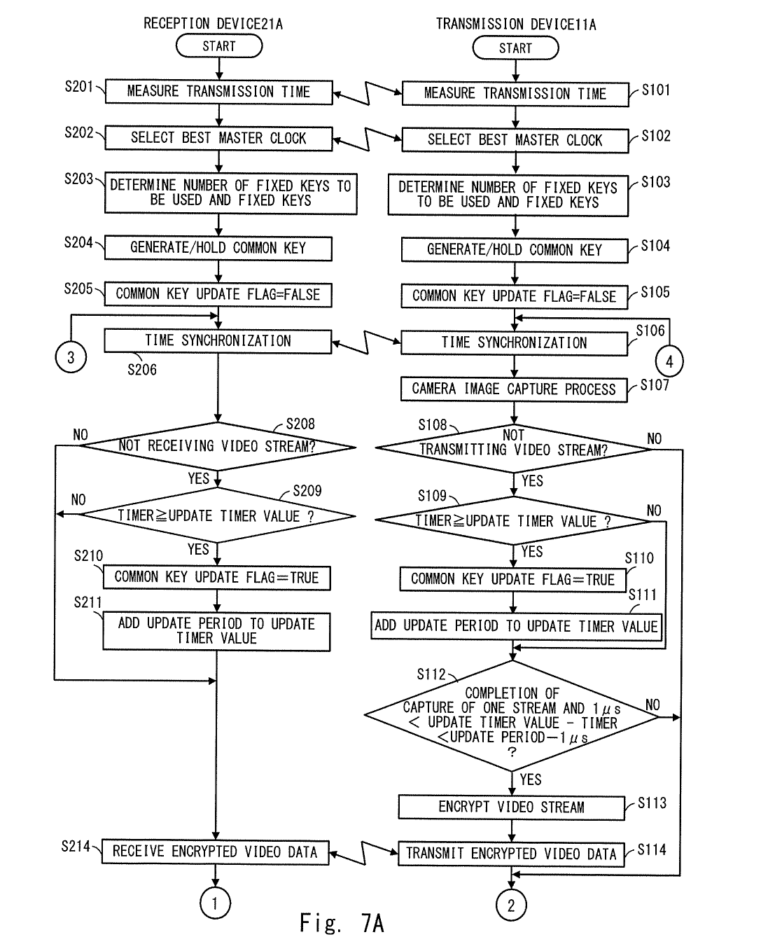

After the key update timing of the common key is reached, the common key update unit 112 updates the common key using an unencrypted video stream of the encrypted video data that starts to be transmitted by the communication unit 115 after the key update timing. Specifically, the common key update unit 112 adds, in units of one byte, an unencrypted video stream of the encrypted video data which starts to be transmitted after the key update timing, and sets the lower 1 byte of the additional value as an index number. The common key update unit 112 includes a fixed key table TB as shown in FIG. 5. The fixed key table TB is a table storing the index number and a fixed key corresponding to the index number. The common key update unit 112 extracts, from the fixed key table TB, the fixed key corresponding to the index number which is the lower 1 byte of the additional value, as a new common key.

The control unit 116 performs various processes by controlling each component in the transmission device 11A. For example, the control unit 116 includes a timer (not shown). When the value of the timer reaches a key update timer value, the control unit 116 determines that the key update timing of the common key is reached, and notifies the common key update unit 112 that the key update timing is reached. Further, the control unit 116 controls the encryption unit 114 so that it does not start encryption of a video stream and controls the communication unit 115 so that is does not start transmission of encrypted video data, in a case where a time when the video stream corresponding to one stream is generated is within a predetermined period before and after the key update timing. In the first embodiment, since a time lag up to 1 μs is generated between the transmission device 11A and the reception device 21A, the predetermined period is 1 μs.

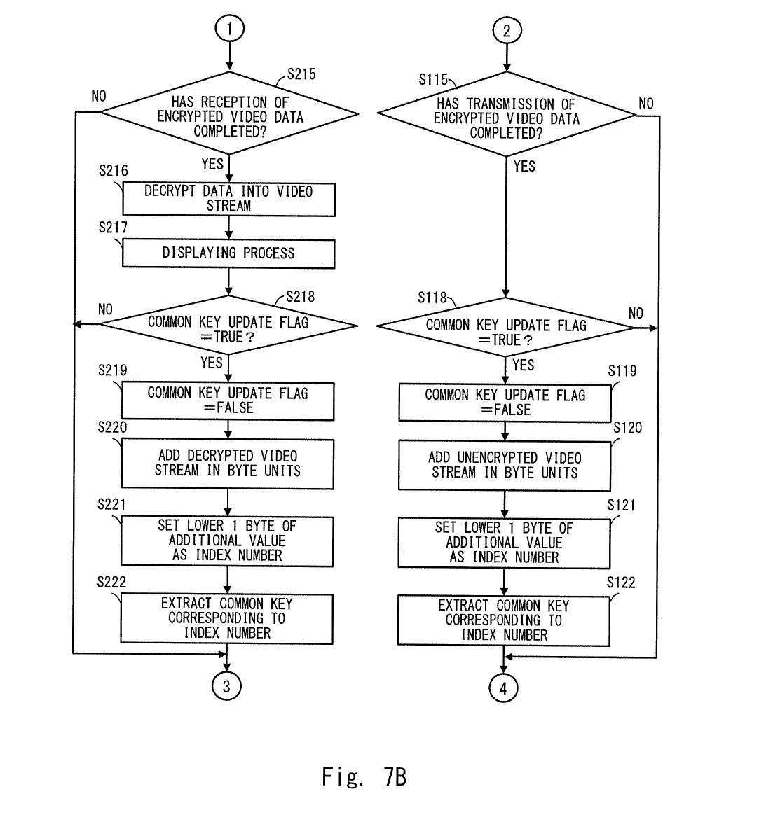

FIG. 6 shows a block configuration example of the reception device 21A according to the first embodiment. As shown in FIG. 6, the reception device 21A according to the first embodiment includes a time synchronization unit 211, a common key update unit 212, a video output unit 213, a decryption unit 214, a communication unit 215, and a control unit 216.

The time synchronization unit 211 performs time synchronization with the transmission device 11A according to the time synchronization function of Ethernet (Registered Trademark) AVB. In the first embodiment, since the reception device 21A is selected as the Grand Master, the transmission device 11A corrects time so that a time lag with respect to the reception device 21A falls within an error range of ±1 μs.

The communication unit 215 communicates with the transmission device 11A. For example, the communication unit 215 receives, from the transmission device 11A, the encrypted video data obtained by encrypting the video stream.

The decryption unit 214 decrypts the encrypted video data received by the communication unit 215 into a video stream using a common key.

After the key update timing of the common key is reached, the common key update unit 212 updates the common key using the video stream obtained by decrypting the encrypted video data which starts to be received by the communication unit 215 after the key update timing. Specifically, the common key update unit 212 adds, in units of one byte, the video stream obtained by decrypting the encrypted video data which starts to be received after the key update timing, and sets the lower 1 byte of the additional value as an index value. Like the common key update unit 112 in the transmission device 11A, the common key update unit 212 also includes the fixed key table TB as shown in FIG. 5. The common key update unit 212 extracts, from the fixed key table TB, a fixed key corresponding to the index number which is the lower 1 byte of the additional value, as a new common key.

The video output unit 213 outputs, to the display 22, the video of the video stream decrypted by the decryption unit 214.

The control unit 216 performs various processes by controlling each component in the reception device 21A. For example, the control unit 216 includes a timer (not shown). When the value of the timer reaches the key update timer value, the control unit 216 determines that the key update timing of the common key is reached, and notifies the common key update unit 212 that the key update timing is reached.

### Operation of First Embodiment

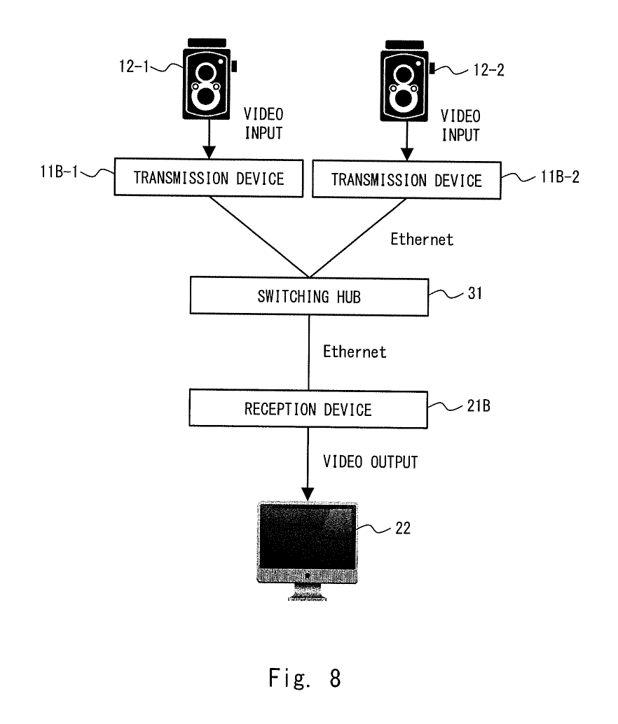

FIGS. 7A and 7B show examples of a communication method performed by the communication system according to the first embodiment. Note that in FIGS. 7A and 7B, the process of steps S115 and S215 shown in FIG. 7B is carried out after the process of steps S114 and S214 shown in FIG. 7A. Further, the process of steps S106 and S206 shown in FIG. 7A is carried out after the process of steps S122 and S222 shown in FIG. 7B.

At first, the transmission device 11A and the reception device 21A perform a common initial operation.

First, in accordance with IEEE Std 802.1AS, the control unit 116 of the transmission device 11A and the control unit 216 of the reception device 21A measure the transmission time from the reception device 21A to the transmission device 11A and the transmission time from the transmission device 11A to the reception device 21A (steps S101 and S201).

Next, in accordance with IEEE Std 802.1AS, the control unit 116 of the transmission device 11A and the control unit 216 of the reception device 21A select, as a best master clock, one of the clocks of the transmission device 11A and the reception device 21A (steps S102 and S202). Assume herein that the clock of the reception device 21A is selected as the best master clock, and the reception device 21A serves as the Grand Master (master) and the transmission device 11A serves as the Slave.

Next, the common key update unit 112 of the transmission device 11A and the common key update unit 212 of the reception device 21A determine the predetermined number (in this case, 256) of fixed keys to be used, and the predetermined fixed keys (steps S103 and S203), thereby fixing the fixed key table TB shown in FIG. 5 and setting the fixed key for the predetermined index number as the common key (steps S104 and S204). Further, the common key update unit 112 of the transmission device 11A and the common key update unit 212 of the reception device 21A set a common key update flag to FALSE as an initial value (steps S105 and S205).

Thus, the initial operation is completed.

Next, in accordance with IEEE Std 802.1AS, the time synchronization unit 111 of the transmission device 11A and the time synchronization unit 111 of the time synchronization unit 211 of the reception device 21A exchange messages, or perform time synchronization by state transition of each state machine (steps S106 and S206). In this case, since the reception device 21A is selected as the Grand Master, the time synchronization unit 111 of the transmission device 11A corrects time so that a time lag with respect to the reception device 21A falls within the error range of ±1 μs in steps S102 and S202.

Next, the video input unit 113 of the transmission device 11A captures the video from the camera image of the camera 12 and inputs the video (step S107).

Next, when the video stream is not being transmitted (YES in step S108) and when the timer value is equal to or greater than the key update timer value (YES in step S109), the common key update unit 112 of the transmission device 11A sets the common key update flag to TRUE (step S110) and an update cycle is added to the key update timer value (step S111). Further, when the audio stream is not being received (YES in step S208) and when the timer value is equal to or greater than the key update timer value (YES in step S209), the common key update unit 212 of the reception device 21A sets the common key update flag to TRUE (step S210), and an update cycle is added to the key update timer value (step S211).

Next, the control unit 116 of the transmission device 11A determines if capturing of the video corresponding to one stream is completed, and if the time falls outside of the range of ±1 μs of the key update timing (step S112). Specifically, when “1 μs<(key update timer value) −timer<(update cycle) −1 μs” is satisfied, it is determined that the time falls outside of the range of ±1 μs of the key update timing.

In step S112, in the transmission device 11A, when capturing of the video corresponding to one stream is completed and when the time falls outside of the range of ±1 μs of the key update timing (YES in step S112), the control unit 116 controls the encryption unit 114 to start encryption of the video stream and controls the communication unit 115 to start transmission of the encrypted video data (steps S113 and S114). The encrypted video data transmitted by the communication unit 115 is received by the communication unit 215 of the reception device 21A (step S214).

On the other hand, in step S112, when capturing of the video corresponding to one stream is not completed, or when the time falls within the range of ±1 μs of the key update timing (NO in step S112), the control unit 116 controls the encryption unit 114 so that it does not start encryption of the video stream and controls the communication unit 115 so that it does not start transmission of the encrypted video data. In other words, in this case, steps S113 and S114 are omitted and the process shifts to step S115.

When the reception device 21A has completed reception of the encrypted video data (YES in step S215), the decryption unit 214 encodes the encrypted video data into a video stream (step S216), and the video output unit 213 outputs the video of the video stream to the display 22 and displays the video (step S217). In this case, when the common key update flag indicates TRUE (YES in step S218), the common key update unit 212 sets the common key update flag to FALSE (step S219), and adds all the decrypted video streams in byte units (step S220). Further, the common key update unit 212 sets the lower 1 byte of the additional value as an index number (step S221), and extracts, as a new common key, the fixed key corresponding to the index number from the fixed key table TB (step S222).

On the other hand, when the transmission device 11A has completed transmission of the encrypted video data (YES in step S115) and the common key update flag indicates TRUE (YES in step S118), the common key update unit 112 sets the common key update flag to FALSE (step S119), and adds all unencrypted video streams in byte units (step S120). Further, the common key update unit 112 sets the lower 1 byte of the additional value as an index number (step S121) and extracts, as a new common key, the fixed value corresponding to the index number from the fixed key table TB (step S122).

After that, the process returns to steps S106 and S206, and the process subsequent to steps S106 and S206 is repeatedly performed.

### Advantageous Effects of First Embodiment

As described above, in the first embodiment, the transmission device 11A updates the common key using the stream that starts to be transmitted after the key update timing, and the reception device 21A updates the common key using the stream that starts to be received after the key update timing. Accordingly, unlike in the technique disclosed in Japanese Unexamined Patent Application Publication No. 2012-147341, the information related to the common key (the information corresponds to the index information in Japanese Unexamined Patent Application Publication No. 2012-147341) is not transmitted onto the communication path between the transmission device 11A and the reception device 21A. Therefore, the security level of communication can be increased as compared with Japanese Unexamined Patent Application Publication No. 2012-147341.

As described above, when there is a stream boundary in a time lag up to 1 μs between the key update timing in the transmission device 11A and the key update timing in the reception device 21A, the streams used for updating the common key in the transmission device 11A may be different from that in the reception device 21A. To avoid this, in the first embodiment, the transmission device 11A sets the period of 1 has before and after the key update timing as the transmission stop period in which the transmission of streams is not started, and does not start the encryption and transmission of streams. Accordingly, the stream used for updating the common key in the transmission device 11A can be matched with the stream used for updating the common key in the reception device 21A.

In the first embodiment, since the time synchronization of Ethernet (Registered Trademark) AVB is performed, the amount of communication information is increased by the amount corresponding to the time synchronization. However, in a communication system in which the time synchronization function of Ethernet (Registered Trademark) AVB is conventionally used, the information related to the common key is not exchanged, which leads to a reduction in the amount of communication information.

### Second Embodiment

### Configuration of Second Embodiment

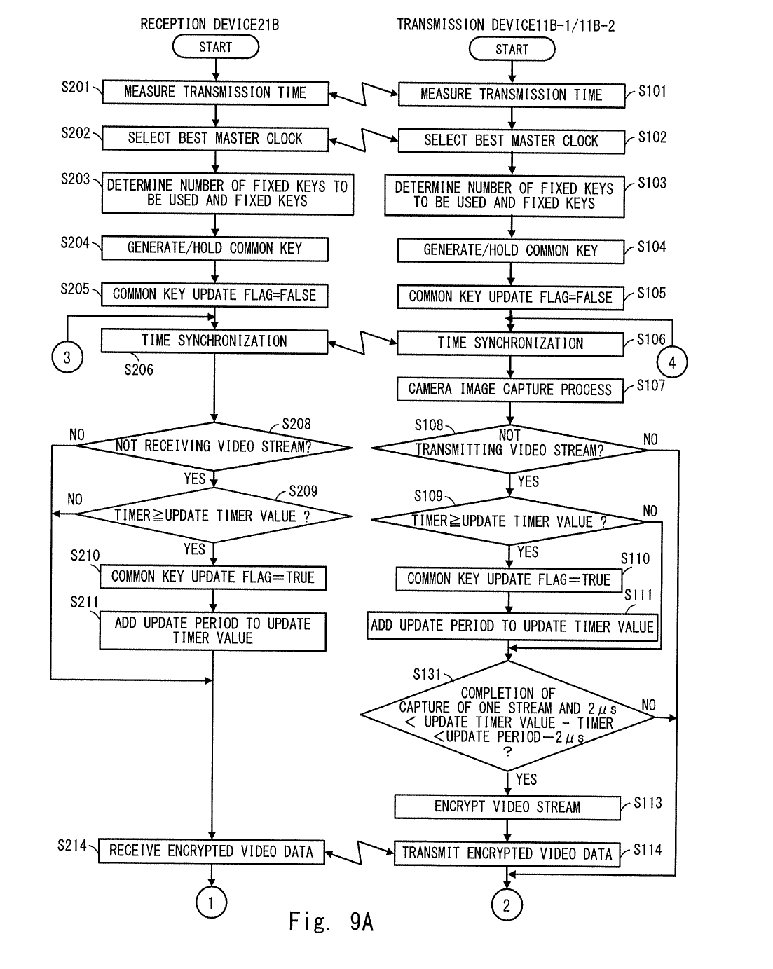

FIG. 8 shows a configuration example of a communication system according to a second embodiment. As shown in FIG. 8, the communication system according to the second embodiment has a configuration in which two transmission devices 11B-1 and 11B-2 and one reception device 21B perform a one-to-multipoint communication. The communication system according to the second embodiment includes two transmission devices 11B-1 and 11B-2, one reception device 21B, two cameras 12-1 and 12-2, one switching hub 31, and one display 22. The two transmission devices 11B-1 and 113-2 and the one reception device 21B are connected via the switching hub 31. One of the transmission devices 11B-1 and 11B-2 is an example of the communication device, and the other one of the transmission devices 11B-1 and 11B-2 is an example of the second other communication device. The reception device 21B is an example of the first other communication device.

The transmission device 11B-1 inputs (receives) a video from the camera image obtained from the camera 12-1, and transmits the encrypted video data obtained by encrypting a video stream to the reception device 21B. The transmission device 11B-2 inputs (receives) a video from the camera image obtained from the camera 12-2, and transmits the encrypted video data obtained by encrypting a video stream to the reception device 21B. The reception device 21B decrypts the encrypted video data received from the transmission devices 11B-1 and 11B-2, and outputs the video to the display 22. The transmission devices 11B-1 and 11B-2 and the reception device 21B perform time synchronization according to the time synchronization function of Ethernet (Registered Trademark) AVB, and the Slave corrects time so that a time lag with respect to the Grand Master falls within the error range of ±1 μs. Assume herein that the reception device 21B is selected as the Grand Master and the transmission devices 11B-1 and 11B-2 are selected as the Slaves.

Note that the block configurations of the transmission devices 11B-1 and 11B-2 according to the second embodiment are similar to the block configuration (FIG. 4) of the transmission device 11A according to the first embodiment, and thus the description thereof is omitted. However, in the second embodiment, three communication devices (the transmission devices 11B-1 and 11B-2 and the reception device 21B) perform one-to-multipoint communication. One of the three communication devices serves as the Grand Master, and a time lag up to 2 μs is generated between the Slaves. Accordingly, the control unit 116 of the transmission devices 11B-1 and 11B-2 sets the period of 2 μs before and after the key update timing as the transmission stop period in which the transmission of video streams is not started, and performs control so that the encryption of the video stream and the transmission of the encrypted video data are not started.

The block configuration of the reception device 21B according to the second embodiment is similar to the block configuration (FIG. 6) of the reception device 21A according to the first embodiment, and thus the description thereof is omitted.

### Operation of Second Embodiment

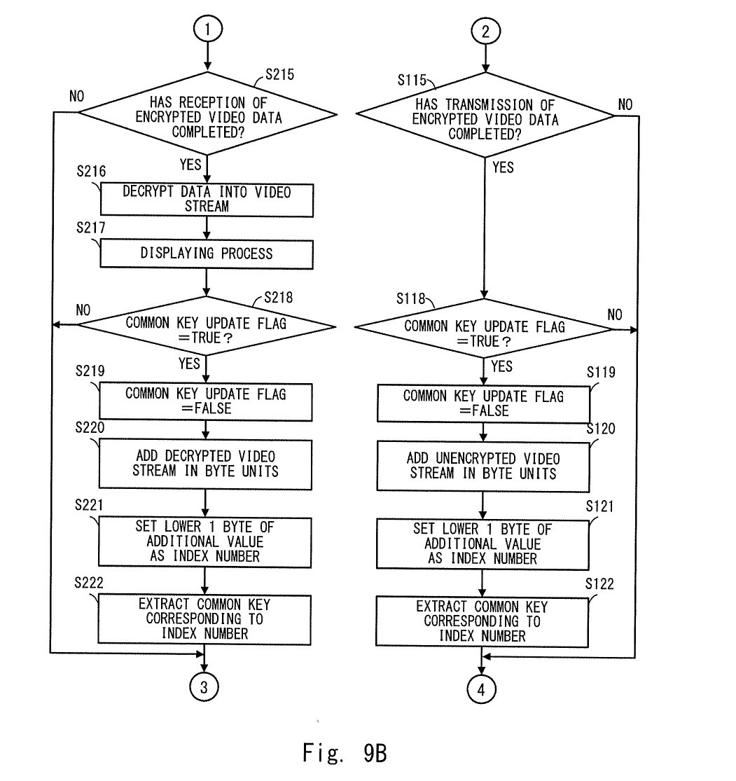

FIGS. 9A and 9B show examples of a communication method performed by the communication system according to the second embodiment. The processes shown in FIGS. 9A and 9B differ from the processes of the first embodiment described above with reference to FIGS. 7A and 7B in that the process for specifying data exchange between the transmission devices 11B-1 and 113-2 and the reception device 21B is performed and step S131 is provided instead of step S112.

First, the transmission devices 11B-1 and 11B-2 perform the process of steps S101 to S111 which are the same as those shown in FIGS. 7A and 7B. On the other hand, the reception device 21B performs the process of steps S201 to S211 which are similar to those shown in FIG. 7A and FIG. 7B.

Next, the control unit 116 of each of the transmission devices 11B-1 and 11B-2 determines if capturing of the video corresponding to one stream is completed and if the time falls outside of the range of ±2 μs of the key update timing (step S131). Specifically, when “2 μs<(key update timer value)−timer<(update cycle)−2 μs” is satisfied, it is determined that the time falls outside of the range of ±2 as of the key update timing.

In step S131, in the transmission devices 11B-1 and 11B-2, when capturing of the video corresponding to one stream is completed and when the time falls outside of the range of ±2 μs of the key update timing (YES in step S131), the control unit 116 controls the encryption unit 114 to start encryption of the video stream and controls the communication unit 115 to start transmission of the encrypted video data (steps S113 and S114). The encrypted video data transmitted by the communication unit 115 is received by the communication unit 215 of the reception device 21B (step S214).

On the other hand, in step S131, when capturing of the video corresponding to one stream is not completed, or when the time falls within the range of ±2 μs of the key update timing (NO in step S131), the control unit 116 controls the encryption unit 114 so that it does not start encryption of the video stream and controls the communication unit 115 so that it does not start transmission of the encrypted video data. In other words, in this case, steps S113 and S114 are omitted and the process shifts to step S115.

After that, the transmission devices 11B-1 and 11B-2 perform the process of steps S115 to S122 which are similar to those shown in FIGS. 7A and 7B. On the other hand, the reception device 21B performs the process of steps S215 to S222 which are similar to those shown in FIGS. 7A and 7B.

After that, the process returns to steps S106 and S206, and the process subsequent to steps S106 and S206 is repeatedly performed.

### Advantageous Effects of Second Embodiment

As described above, in the second embodiment, the transmission devices 11B-1 and 11B-2 updates the common key using the stream that starts to be transmitted after the key update timing, and the reception device 21B updates the common key using the stream that starts to be received after the key update timing. Accordingly, unlike in the technique disclosed in Japanese Unexamined Patent Application Publication No. 2012-147341, the information related to the common key (the information corresponds to the index information in Japanese Unexamined Patent Application Publication No. 2012-147341) is not transmitted onto the communication path between the transmission devices 11B-1 and 11B-2 and the reception device 213. Therefore, the security level of communication can be increased as compared with Japanese Unexamined Patent Application Publication No. 2012-147341.

As described above, a stream boundary may be present in a time lag between the key update timing in the transmission devices 11B-1 and 11B-2 and the key update timing in the reception device 21B (in the second embodiment, since the reception device 21B is selected as the Grand Master, this time lag is 1 μs at maximum, while when one of the transmission devices 11B-1 and 11B-2 is selected as the Grand Master, the time lag is 2 μs at maximum). In this case, the stream used for updating the common key in the transmission devices 11B-1 and 11B-2 may be different from that in the reception device 21B. To avoid this, in the second embodiment, the transmission devices 11B-1 and 11B-2 set a period of 2 μs before and after the key update timing as the transmission step period in which the transmission of streams is not started, and do not start the encryption and transmission of streams. Accordingly, the stream used for updating the common key in the transmission devices 11B-1 and 11B-2 can be matched with the stream used for updating the common key in the reception device 21B.

In the second embodiment, two transmission devices 11B-1 and 11B-2 are provided and a time lag up to 2 μs may be generated between the transmission devices 11B-1 and 11B-2 and the reception device 21B. Accordingly, the transmission devices 11B-1 and 11B-2 set the period within 2 μs before and after the update timing as the transmission stop period in which the transmission of streams is not started. Therefore, in the second embodiment, the transmission stop period in the transmission devices 11B-1 and 11B-2 is twice the transmission stop period in the first embodiment in which one transmission device 11A is provided. In this case, however, if three or more transmission devices are provided, a time lag between the transmission devices and the reception device is within a range of 2 μs at maximum, and thus the transmission stop period is less than twice that of the first embodiment.

Further, in the second embodiment, since the time synchronization of Ethernet (Registered Trademark) AVB is performed, the amount of communication information is increased by the amount corresponding to the time synchronization. However, in a communication system in which the time synchronization function of Ethernet (Registered Trademark) AVB is conventionally used, the information related to the common key is not exchanged, which leads to a reduction in the amount of communication information.

### Third Embodiment

### Configuration of Third Embodiment

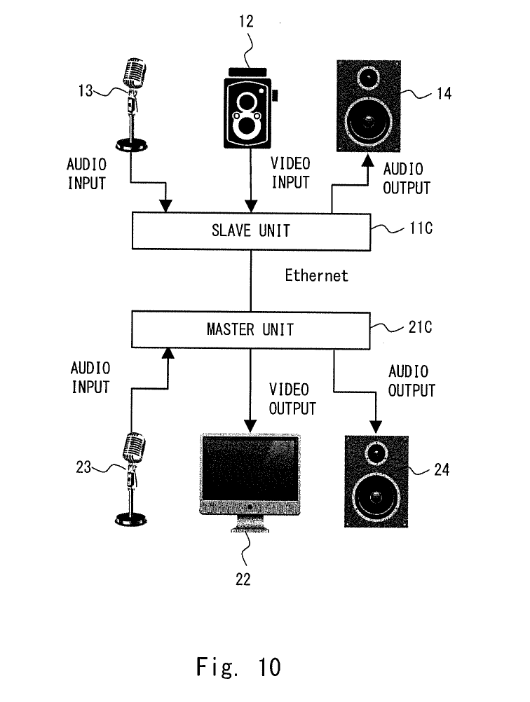

FIG. 10 shows a configuration example of a communication system according to a third embodiment. As shown in FIG. 10, the communication system according to the third embodiment has a configuration in which one slave unit 11C, which has a video transmission function and an audio transmission/reception function, and one master unit 21C, which has a video reception function and an audio transmission/reception function, perform a one-to-one communication. The communication system according to the third embodiment includes one slave unit 11C, one master unit 21C, one camera 12, one display 22, two microphones 13 and 23, and two speakers 14 and 24. The one slave unit 11C and the one master unit 21C are directly connected to each other. The slave unit 11C is an example of the communication device and the master unit 21C is an example of the first other communication device.

The slave unit 110 inputs (receives) the video from the camera image obtained from the camera 12, inputs (receives) audio from the microphone 13, and transmits the encrypted video data obtained by encrypting the video stream and the encrypted audio data obtained by encrypting an audio stream to the master unit 21C. The master unit 21C decrypts the encrypted video data received from the slave unit 11C into a video stream, outputs the video to the display 22, decrypts the encrypted audio data received from the slave unit 11C into an audio stream, and outputs the audio to the speaker 24. Further, the master unit 21C inputs (receives) audio from the microphone 23 and transmits the encrypted audio data obtained by encrypting the audio stream to the slave unit 11C. The slave unit 11C decrypts the encrypted audio data received from the master unit 21C into an audio stream, and outputs the audio to the speaker 14.

The slave unit 11C and the master unit 21C perform the time synchronization according to the time synchronization function of Ethernet (Registered Trademark) AVB, and the Slave corrects time so that a time lag with respect to the Grand Master falls within the error range of ±1 μs. In this case, the master unit 21C is selected as the Grand Master and the slave unit 11C is selected as the Slave.

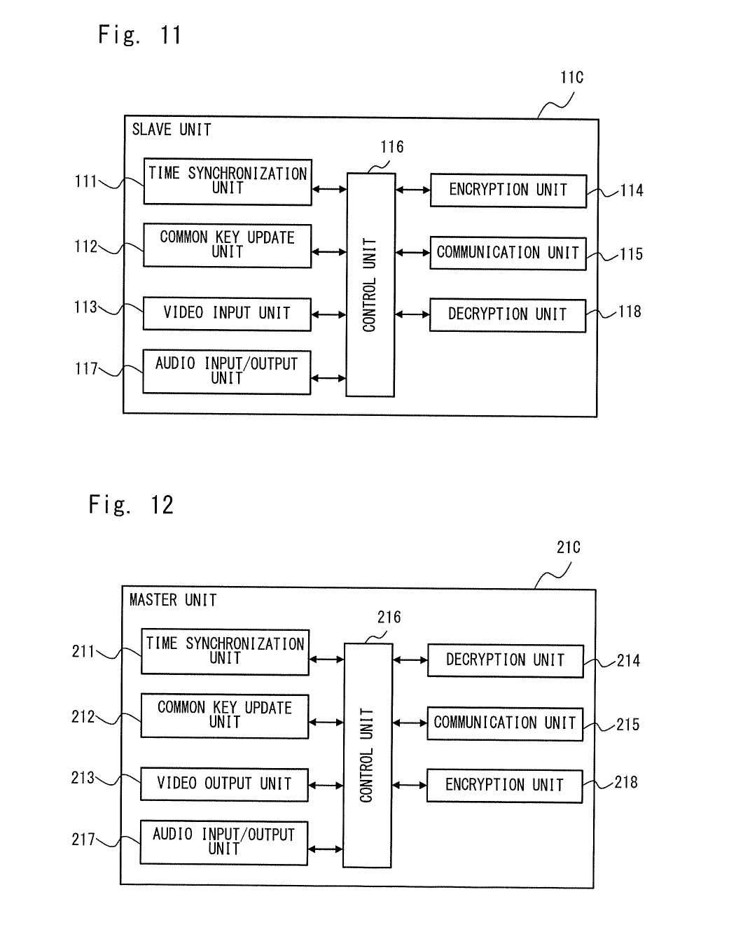

FIG. 11 shows a block configuration example of the slave unit 11C according to the third embodiment. As shown in FIG. 11, the slave unit 11C according to the third embodiment differs from the transmission device 11A according to the first embodiment described above with reference to FIG. 4 in that the slave unit 11C includes an audio input/output unit 117 and a decryption unit 118. Differences between the slave unit 11C according to the third embodiment and the transmission device 11A according to the first embodiment will be described below.

The audio input/output unit 117 inputs (receives) audio from the microphone 13.

The encryption unit 114 encrypts the video stream inputted (received) by the video input unit 113 into encrypted video data using a common key. In addition, the encryption unit 114 encrypts the audio stream inputted (received) by the audio input/output unit 117 into encrypted audio data using a common key.

The communication unit 115 transmits, to the master unit 21C, the encrypted video data and encrypted audio data which are encrypted by the encryption unit 114.

The control unit 116 controls the encryption unit 114 so that it does not start encryption of the video stream and controls the communication unit 115 so that it does not start transmission of the encrypted video data, in a case where a time when the video stream corresponding to one stream is generated falls within a range of 1 μs before and after the key update timing. In addition, the control unit 116 controls the encryption unit 114 so that it does not start encryption of the audio stream and controls the communication unit 115 so that it does not start transmission of the encrypted audio data, in a case where a time when the audio stream corresponding to one stream is generated falls within the range of 1 μs before and after the key update timing.

The communication unit 115 receives, from the master unit 21C, the encrypted audio data obtained by encrypting an audio stream.

The decryption unit 118 decrypts the encrypted audio data received by the communication unit 115 into an audio stream using a common key.

The audio input/output unit 117 outputs, to the speaker 14, the audio of the audio stream decrypted by the decryption unit 118.

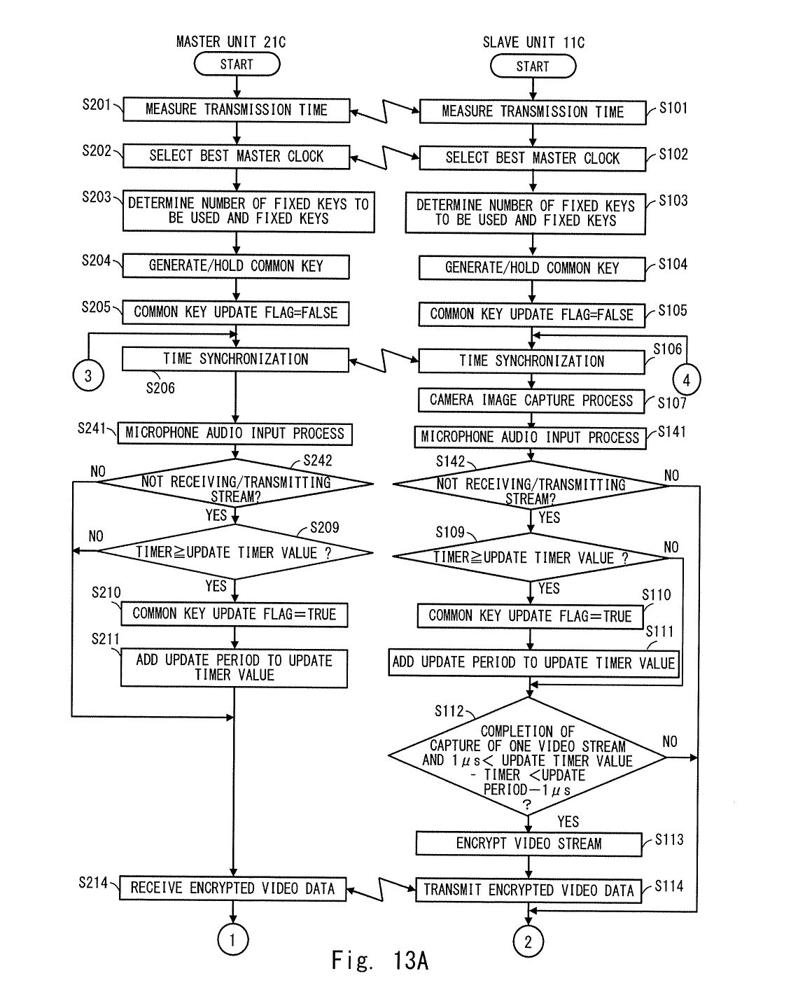

FIG. 12 shows a block configuration example of the master unit 21C according to the third embodiment. As shown in FIG. 12, the master unit 21C according to the third embodiment differs from the reception device 21A according to the first embodiment described above with reference to FIG. 6 in that the master unit 21C includes an audio input/output unit 217 and an encryption unit 218. The differences between the master unit 21C according to the third embodiment and the reception device 21A according to the first embodiment will be described below.

The communication unit 215 receives, from the slave unit 11C, the encrypted video data obtained by encrypting the video stream and the encrypted audio data obtained by encrypting the audio stream.

The decryption unit 214 decrypts the encrypted video data received by the communication unit 215 into a video stream using a common key. In addition, the decryption unit 214 decrypts the encrypted audio data received by the communication unit 215 into an audio stream using a common key.

The audio input/output unit 217 outputs, to the speaker 24, the audio of the audio stream decrypted by the decryption unit 214.

The audio input/output unit 217 inputs (receives) the audio from the microphone 23.

The encryption unit 218 encrypts the audio stream inputted (received) by the audio input/output unit 217 into encrypted audio data using a common key.

The communication unit 215 transmits, to the slave unit 11C, the encrypted audio data encrypted by the encryption unit 218.

The control unit 216 controls the encryption unit 218 so that it does not start encryption of the audio stream and controls the communication unit 215 so that it does not start transmission of the encrypted audio stream, in a case where a time when the audio stream corresponding to one stream is generated falls within the range of 1 μs before and after the key update timing.

### Operation of Third Embodiment

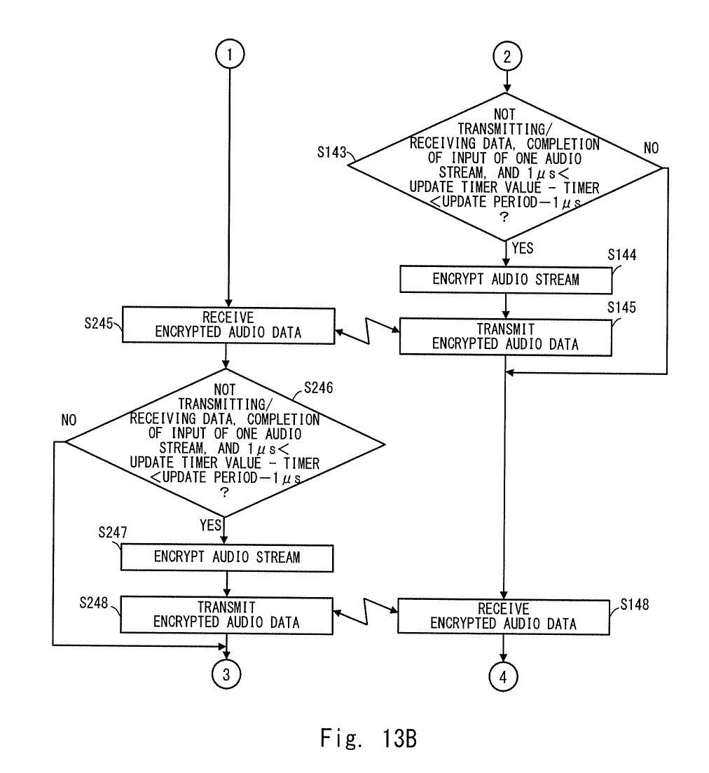

FIGS. 13A, 13B, and 13C show examples of a communication method performed by the communication system according to the third embodiment. The processes shown in FIGS. 13A, 13B, and 13C differ from the processes of the first embodiment described above with reference to FIGS. 7A and 7B in that the process for specifying data exchange between the slave unit 11C and the master unit 21C is provided; steps S142 and S242 are provided instead of steps S108 and S208; and steps S141, S143 to S155, S241, and S243 to S255 are added. Note that in FIGS. 13A, 13B, and 13C, the process of steps S143 and S245 shown in FIG. 13B is performed after the process of steps S114 and S214 shown in FIG. 13A. Further, the process of steps S115 and S215 is performed after the process of steps S148 and S248 shown in FIG. 13B. Furthermore, the process of steps S106 and S206 shown in FIG. 13A is performed after the process of steps S155 and S255 shown in FIG. 13C.

First, the slave unit 11C performs the process of steps S101 to S107 which are similar to those shown in FIGS. 7A and 7B. On the other hand, the master unit 21C performs the process of steps S201 to S206 which are similar to those shown in FIGS. 7A and 7B.

Next, in the slave unit 11C, after capturing of the camera image in step S107, the audio input/output unit 117 inputs (receives) the audio from the microphone 13 (step S141). On the other hand, in the master unit 21C, the audio input/output unit 217 inputs (receives) the audio from the microphone 23 (step S241).

Next, in the slave unit 11C, when both the video stream and the audio stream are not being transmitted/received (YES in step S142) and when the timer value is equal to or greater than the key update timer value, the common key update unit 112 sets the common key update flag to TRUE (step S110), and an update cycle is added to the key update timer value (step S111). When capturing of the video corresponding to one stream is completed and when the time falls outside of the range of ±1 μs of the key update timing (YES in step S112), the control unit 116 controls the encryption unit 114 to start encryption of the video stream and controls the communication unit 115 to start transmission of the encrypted video data (steps S113 and S114).

On the other hand, in the master unit 210, when both the video stream and the audio stream are not being transmitted/received (YES in step S242) and when the timer value is equal to or greater than the key update timer value (YES in step S209), the common key update unit 212 sets the common key update flag to TRUE (step S210) and an update cycle is added to the key update timer value (step S211). Further, in step S114, when the slave unit 11C has transmitted the encrypted video data, the encrypted video data is received by the communication unit 215 (step S214).

Next, the control unit 116 of the slave unit 11C determines if both the video stream and the audio stream are not being transmitted/received, if the input (reception) of the audio corresponding to one stream is completed, and if the time falls outside the range of ±1 μs of the key update timing (step S143). Specifically, when “1 μs<(key update timer value) −(timer value) <(update cycle) −1 μs” is satisfied, it is determined that the time falls outside the range of ±1 μs of the key update timing.

In step S143, in the slave unit 11C, when both the video stream and the audio stream are not being transmitted/received, and when the input (reception) of the audio corresponding to one stream is completed, and when the time falls outside of the range of ±1 μs of the key update timing (YES in step S143), the control unit 116 controls the encryption unit 114 to start encryption of the audio stream and controls the communication unit 115 to start transmission of the encrypted audio data (steps S144 and S145). The encrypted audio data transmitted by the communication unit 115 is received by the communication unit 215 of the master unit 21C (step S245).

On the other hand, in step S143, when the video stream or the audio stream is being transmitted or received, or when the input (reception) of the audio corresponding to one stream is not completed, or when the time falls within the range of ±1 μs of the key update timing (NO in step S143), the control unit 116 controls the encryption unit 114 so that it does not start encryption of the audio stream and controls the communication unit 115 so that it does not start transmission of the encrypted audio data. In other word, in this case, steps S144 and S145 are omitted and the process shifts to step S148.

Next, the control unit 216 of the master unit 21C determines if both the video stream and the audio stream are not being transmitted/received, if the input (reception) of the audio corresponding to one stream is completed, and if the time falls outside the range of ±1 μs of the key update timing (step S246). Specifically, if “1 μs<(key update timer value) −timer<(update cycle) −1 μs” is satisfied, it is determined that the time falls outside of the range of ±1 μs of the key update timing.

In step S246, in the master unit 21C, when both the video stream and the audio stream are not being transmitted/received, when the input (reception) of the audio corresponding to one stream is completed, and when the time falls outside of the range of ±1 μs of the key update timing (YES in step S246), the control unit 216 controls the encryption unit 218 to start encryption of the audio stream and controls the communication unit 215 to start transmission of the encrypted audio data (steps S247 and S248). The encrypted audio data transmitted by the communication unit 215 is received by the communication unit 115 of the slave unit 11C (step S148).

On the other hand, in step S246, when the video stream or the audio stream is being transmitted or received, or when the input (reception) of the audio corresponding to one stream is not completed, or when the time falls within the range of ±1 μs of the key update timing (NO in step S246), the control unit 216 controls the encryption unit 218 so that it does not start encryption of the audio stream and controls the communication unit 215 so that it does not start transmission of the encrypted audio data. In other words, in this case, steps S247 and S248 are omitted and the process shifts to step S215.

Next, in the slave unit 11C, when the transmission of the encrypted video data is completed (YES in step S115), the process of a common key update determination 2 to be described later is performed (step S149).

On the other hand, in the master unit 210, when the reception of the encrypted video data is completed (YES in step S215), the decryption unit 214 decrypts the encrypted video data into a video stream (step S216), and the video output unit 213 outputs the video of the video stream to the display 22, and displays the video (step S217). Next, the process of a common key update determination 1 to be described later is performed (step S249).

Next, in the slave unit 11C, when the transmission of the encrypted audio data is completed (YES in step S150), the process of the common key update determination 2 to be described later is performed (step S151).

On the other hand, in the master unit 21C, when the transmission of the encrypted audio data is completed (YES in step S250), the process of the common key update determination 2 to be described later is performed (step S251).

Next, in the slave unit 11C, when the reception of the encrypted audio data is completed (YES in step S152), the decryption unit 118 decrypts the encrypted audio data into an audio stream (step S153), and the audio input/output unit 117 outputs the audio of the audio stream to the speaker 14 (step S154). Next, the process of the common key update determination 1 to be described later is performed (step S155).

On the other hand, in the master unit 21C, when the reception of the encrypted audio data is completed (YES in step S252), the decryption unit 214 decrypts the encrypted audio data into an audio stream (step S253), and the audio input/output unit 217 outputs the audio of the audio stream to the speaker 24 (step S254). Next, the process of the common key update determination 1 to be described later is performed (step S255).

After that, the process returns to steps S106 and S206, and the process subsequent to step S106 and S206 is repeatedly performed.

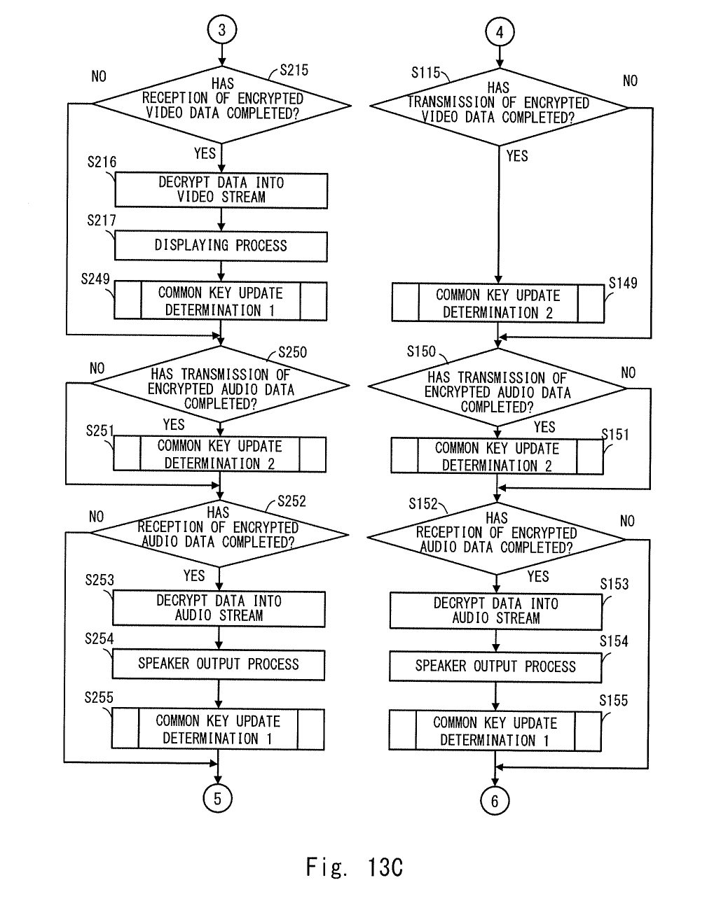

FIG. 14 shows an example of the processes of the common key update determinations 1 and 2 shown in FIG. 13C.

The common key update determination 1 is a process that is performed, when the reception of the encrypted video data or the encrypted audio data is completed, by the common key update unit 112 of the slave unit 11C which has received the encrypted video data or the encrypted audio data, or by the common key update unit 212 of the master unit 21C which has received the encrypted video data or the encrypted audio data. Specifically, when the common key update flag indicates TRUE (YES in step S261), the common key update flag is first set to FALSE (step S262). Next, all the decrypted video streams or audio streams are added in byte units (step S263), and the lower 1 byte of the additional value is set as an index number (step S264). After that, the fixed key corresponding to the index number is extracted from the fixed key table TB as a new common key (step S265).

On the other hand, the common key update determination 2 is a process that is performed, when the transmission of the encrypted video data or encrypted audio data is completed, by the common key update unit 112 of the slave unit 11C which has transmitted the encrypted video data or encrypted audio data, or by the common key update unit 212 of the master unit 21C which has transmitted the encrypted video data or encrypted audio data. Specifically, when the common key update flag indicates TRUE (YES in step S161), the common key update flag is first set to FALSE (step S162). Next, all the unencrypted video streams or audio streams are added in byte units (step S163), and the lower 1 byte of the additional value is set as the index number (step S164). After that, the fixed key corresponding to the index number is extracted from the fixed key table TB as a new common key (step S165).

### Advantageous Effects of Third Embodiment

As described above, in the third embodiment, the slave unit 11C and the master unit 21C update the common key using the stream that starts to be transmitted or received after the update timing, regardless of whether the stream is a video stream or an audio stream. Accordingly, unlike in the technique disclosed in Japanese Unexamined Patent Application Publication No. 2012-147341, the information related to the common key (this information corresponds to the index information in Japanese Unexamined Patent Application Publication No. 2012-147341) is not transmitted onto the communication path between the slave unit 11C and the master unit 21C. Therefore, the security level of communication can be increased as compared with Japanese Unexamined Patent Application Publication No. 2012-147341.

As described above, when there is a stream boundary in a time lag up to 1 μs between the update timing in the slave unit 11C and the update timing in the master unit 21C, the streams used for updating the common key in the slave unit 110 may be different from that in the master unit 21C. To avoid this, in the third embodiment, the slave unit 11C and the master unit 21C set a period of 1 μs before and after the update timing as the transmission stop period in which the transmission of the video stream or the audio stream is not started, and do not start the encryption and transmission of the video stream or the audio stream. Accordingly, the stream used for updating the common key in the slave unit 11C can be matched with the stream used for updating the common key in the master unit 21C.

Further, in the third embodiment, since the time synchronization of Ethernet (Registered Trademark) AVB is performed, the amount of communication information is increased by the amount corresponding to the time synchronization. However, in a communication system in which the time synchronization function of Ethernet (Registered Trademark) AVB is conventionally used, the information related to the common key is not exchanged, which leads to a reduction in the amount of communication information.

### Fourth Embodiment

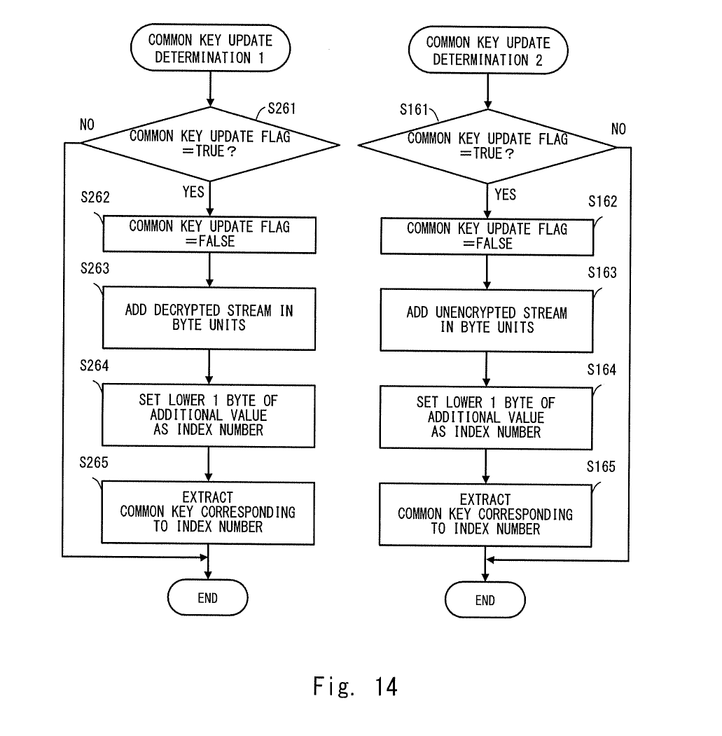

FIG. 15 shows a configuration example of a communication system according to a fourth embodiment. The communication system according to the fourth embodiment is an example of a communication system in which four cameras are attached to a vehicle, and people present in the vicinity of the vehicle are detected based on videos obtained from four cameras. As shown in FIG. 15, the communication system according to the fourth embodiment has a configuration in which four transmission devices C1 to C4 and one reception device M1 perform one-to-multipoint communication. The communication system according to the fourth embodiment includes four transmission devices C1 to C4, one reception device M1, one switching hub H1, and one speaker S1. The four transmission devices C1 to C4 and the one reception device M1 are connected via the switching hub H1. Any one of the transmission devices C1 to C4 is an example of the communication device, and the other transmission devices are examples of the second other communication device. The reception device M1 is an example of the first other communication device.

The four transmission devices C1 to C4 input (receive) videos from the camera images obtained from the respective cameras, and transmit the encrypted video data obtained by encrypting the video stream to the reception device M1. The reception device M1 decrypts the encrypted video data received from the four transmission devices C1 to C4 into video streams, performs viewpoint conversion of each video corresponding to the four transmission devices into images viewed from above the vehicle, and synthesizes the images into a virtual image of the vehicle, thereby generating one top view image. Based on the top view image, the reception device M1 detects people in the vicinity of the vehicle by using an HOG (Histogram of Oriented Gradient)+SVM (Support Vector Machine) algorithm or the like, and outputs an alarm to the speaker S1 when people are detected. The transmission devices C1 to C4 and the reception device M1 perform the time synchronization according to the time synchronization function of Ethernet (Registered Trademark) AVB, and correct time so that a time lag with respect to the Grand Master falls within an error range of ±1 μs.

In the fourth embodiment, the four transmission devices C1 to C4 and the one reception device M1 perform one-to-multipoint communication, and thus the fourth embodiment is similar to the second embodiment in that one-to-multipoint communication is performed.

Accordingly, like in the second embodiment, the transmission devices C1 to C4 update the common key using the stream that starts to be transmitted after the update timing, and the reception device M1 updates the common key using the stream that starts to be received after the update timing.

Further, there is a possibility that a time lag up to 2 μs is generated between the reception device M1 and the transmission devices C1 to C4. Accordingly, like in the second embodiment, the transmission devices C1 to C4 set a period within 2 μs before and after the update timing as the transmission stop period in which the transmission of the video stream is not started.

Therefore, the block configurations of the transmission devices C1 to C4 and the reception device M1 according to the fourth embodiment are similar to block configurations (FIGS. 4 and 6) of the transmission devices 11B-1 and 11B-2 and the reception device 21B according to the second embodiment, and thus the descriptions thereof are omitted.

The communication method performed by the communication system according to the fourth embodiment is also similar to the communication method (FIGS. 7A and 7B) by the communication system according to the second embodiment, and thus the descriptions thereof are omitted.

As described above, in the fourth embodiment, the transmission devices C1 to C4 update the common key by using the stream that starts to be transmitted after the update timing, and the reception device M1 updates the common key by using the stream that starts to be received after the update timing.

Accordingly, unlike in Japanese Unexamined Patent Application Publication No. 2012-147341, the information (index information in Japanese Unexamined Patent Application Publication No. 2012-147341) related to the common key is not sent to the communication path between the reception device M1 and the transmission devices C1 to C4. Accordingly, the security level of the communication can be increased as compared with Japanese Unexamined Patent Application Publication No. 2012-147341. Thus, the video data for the four devices can be prevented from being referred to or altered by a third party.

The other advantageous effects are similar to those of the second embodiment.

### Concepts of First to Fourth Embodiments

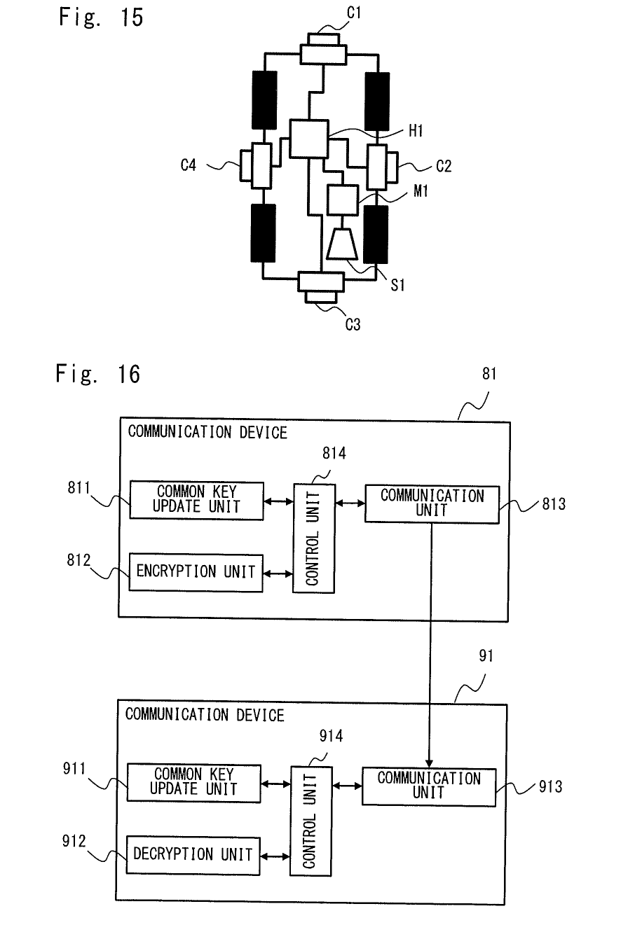

FIG. 16 shows a conceptual block configuration diagram example of the communication system according to the first to fourth embodiments. The communication system shown in FIG. 16 has a configuration in which one communication device 81 and one communication device 91 perform one-to-one communication. The one communication device 81 and the one communication device 91 are directly connected to each other. The communication device 81 corresponds to the transmission devices 11A, 11B-1, 11B-2, and C1 to C4 and the slave unit 11C according to the first to fourth embodiments, and is an example of the communication device. The communication device 91 corresponds to the reception devices 21A, 21B-1, 21B-2, and M1 and the master unit 21C according to the first to fourth embodiments, and is an example of the first other communication device.

The communication device 81 transmits encrypted data, which is obtained by encrypting a stream, to the communication device 91, and includes a common key update unit 811, an encryption unit 812, a communication unit 813, and a control unit 814.

The encryption unit 812 encrypts the stream, which is transmitted to the communication device 91, into the encrypted data using a common key. The encryption unit 812 corresponds to the encryption unit 114 according to the first to fourth embodiments.

The communication unit 813 transmits the encrypted data, which is encrypted by the encryption unit 114, to the communication device 91. The communication unit 813 corresponds to the communication unit 115 according to the first to fourth embodiments.

After the key update timing of the common key is reached, the common key update unit 811 updates the common key by using an unencrypted stream of the encrypted data that starts to be transmitted by the communication unit 813 after the key update timing. The common key update unit 811 corresponds to the common key update unit 112 according to the first to fourth embodiments. Specifically, the common key update unit 811 adds, in byte units, the unencrypted stream of the encrypted data that starts to be transmitted after the key update timing, and sets the lower 1 byte of the additional value as an index number. The common key update unit 811 includes the fixed key table TB shown in FIG. 5. The common key update unit 811 extracts the fixed key corresponding to the index number, which is the lower 1 byte of the additional value, from the fixed key table TB as a new common key.

The control unit 814 performs various processes by controlling each component in the communication device 81. For example, the control unit 814 controls the encryption unit 812 so that it does not start the encryption of the stream and controls the communication unit 813 so that it does not start the transmission of the encrypted data, in a case where a time when the stream to be transmitted to the communication device 91 is generated falls within a predetermined period before and after the key update timing. The control unit 814 corresponds to the control unit 116 according to the first to fourth embodiments.

The control unit 814 controls the encryption unit 812 to start the encryption of the stream and controls the communication unit 813 to start the transmission of the encrypted data, in a case where a time when the stream to be transmitted to the communication device 91 is generated falls outside of the predetermined period before and after the key update timing.

The communication device 91 decrypts the encrypted data received from the communication device 81 into a stream, and includes a common key update unit 911, a decryption unit 912, a communication unit 913, and a control unit 914.

The communication unit 913 receives, from the communication device 91, the encrypted data obtained by encrypting the stream by the common key. The communication unit 913 corresponds to the communication unit 215 according to the first to fourth embodiments.

The decryption unit 912 decrypts the encrypted data received by the communication unit 913 into a stream by using the common key. The decryption unit 912 corresponds to the decryption unit 214 corresponding to the first to fourth embodiments.

The common key update unit 911 updates the common key using the stream obtained by decrypting the encrypted data which has started to be received by the communication unit 913 after the key update timing after the key update timing of the common key. The common key update unit 911 corresponds to the common key update unit 212 according to the first to fourth embodiments.

Specifically, the common key update unit 911 adds, in units of one byte, streams obtained by decrypting the encrypted data which starts to be transmitted or received after the key update timing, and sets the lower one byte of the additional value as an index number. The common key update unit 911 includes the fixed key table TB as shown in FIG. 5. The common key update unit 911 extracts, from the fixed key table TB, the fixed key corresponding to the index number, which is the lower 1 byte of the additional value, as a new common key.

The control unit 914 performs various processes by controlling each component in the communication device 91.

In this case, the communication device 81 may further include a time synchronization unit (corresponding to the time synchronization unit 111 according to the first to fourth embodiments) that corrects time so that a time lag between the communication device 91 and the communication device 81 falls within a predetermined error range. In this case, a time lag corresponding to a maximum predetermined error is generated between the communication device 91 and the communication device 81. Accordingly, the control unit 814 sets the above-mentioned predetermined period as the predetermined error range.

Not only the two communication devices 81 and 91, but also the other communication device (second other communication device) that transmit the stream to the communication device 91 or receives the stream from the communication device 81 may be present. In this case, the time synchronization unit corrects time so that the time lag between the communication device 91 or the other communication device and the communication device 81 fall within a predetermined error range. A time lag that is twice larger than the predetermined error range at maximum is generated between the communication device 91 or the other communication device and the communication device 81. Accordingly, the control unit 814 sets the predetermined period to be twice as large as the predetermined error range.

The communication device 81 may be configured to receive the encrypted data obtained by encrypting a stream by using a common key, from the communication device 91 or other communication devices described above. In this case, after the common key update timing is reached, the common key update unit 811 may update the common key by using the unencrypted stream of the encrypted data that starts to be transmitted when the communication unit 813 has started the transmission of the encrypted data prior to the reception of the encrypted data after the update timing. On the other hand, after the common key update timing is reached, when the communication unit 813 has started the reception of the encrypted data prior to the transmission of the encrypted data after the update timing, the common key update unit 811 may update the common key by using the stream obtained by encoding the encrypted data that starts to be received. Note that the method of updating the common key using the stream obtained by decrypting the encrypted data is similar to the method of updating the common key using the unencrypted stream.

The invention made by the present inventors has been described in detail above based on embodiments. However, the present invention is not limited to the above embodiments, and can be modified in various ways without departing from the scope of the invention.

For example, the above embodiments illustrate an example in which the communication devices perform one-to-one communication and one-to-multipoint communication, but the present invention is not limited to this. The communication devices may perform multipoint-to-multipoint communication.

The first, second, third and fourth embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A communication device comprising:
an encryption unit configured to encrypt a stream to be transmitted to a first other communication device into encrypted data using a common key;
a communication unit configured to transmit the encrypted data to the first other communication device, the encrypted data being encrypted using the common key,
a common key update unit configured to update, after an update timing of the common key is reached, the common key using an unencrypted stream of the encrypted data that starts to be transmitted by the communication unit after the update timing; and
a control unit configured to control the encryption unit so that the encryption unit does not start the encryption of the stream and control the communication unit so that the communication unit does not start the transmission of the encrypted data, in a case where a time when the stream to be transmitted to the first other communication device is generated is within the predetermined period before and after the update timing.

2. The communication device according to claim 1, wherein, the control unit controls the encryption unit to start the encryption of the stream and controls the communication unit to start the transmission of the encrypted data, in a case where a time when the stream to be transmitted to the first other communication device is generated is outside of the predetermined period before and after the update timing.

3. The communication device according to claim 1, further comprising a time synchronization unit configured to correct time in such a manner that a time lag between the first other communication device and the communication device falls within a predetermined error range,
wherein the control unit sets the predetermined period as the predetermined error range.

4. The communication device according to claim 1, further comprising a time synchronization unit configured to correct time in such a manner that when there is a second other communication device configured to transmit a stream to the first other communication device or receive a stream from the communication device, a time lag between the communication device and the first or second other communication device falls within a predetermined error range,
wherein the control unit sets the predetermined period to be twice the predetermined error range.

5. The communication device according to claim 1, wherein
the communication unit receives the encrypted data from the first other communication device,
the communication device further includes a decryption unit configured to decrypt encrypted data received from the first other communication device into a stream by using the common key, and
after the common key update timing is reached, the common key update unit updates the common key by using an unencrypted stream of the encrypted data that starts to be transmitted, when the communication unit starts the transmission of the encrypted data prior to the reception of the encrypted data after the update timing.

6. The communication device according to claim 5, wherein after the common key update timing is reached, the common key update unit updates the common key by using a stream obtained by decrypting the encrypted data that starts to be received, when the communication unit has started the reception of the encrypted data prior to the transmission of the encrypted data after the update timing.

7. The communication device according to claim 5, wherein
the common key update unit includes a fixed key table storing an index number and a fixed key corresponding to the index number, and
after the common key update timing is reached, the common key update unit adds, in byte units, an unencrypted stream of the encrypted data that starts to be transmitted, sets a lower 1 byte of the additional value as an index number, acquires a fixed key corresponding to the index number from the fixed key table, and updates the common key to the acquired fixed key, when the communication unit has started the transmission of the encrypted data prior to the reception of the encrypted data after the update timing.

8. The communication device according to claim 6, wherein
the common key update unit includes a fixed key table storing an index number and a fixed key corresponding to the index number, and
after the common key update timing is reached, the common key update unit adds, in byte units, a stream obtained by decrypting the encrypted data that starts to be received, sets a lower 1 byte of the additional value as an index number, acquires a fixed key corresponding to the index number from the fixed key table, and updates the common key to the acquired fixed key, when the communication unit has started the reception of the encrypted data prior to the transmission of the encrypted data after the update timing.

9. A communication system comprising:
a communication device; and
a first other communication device, wherein
the communication device includes:
an encryption unit configured to encrypt a stream to be transmitted to the first other communication device into encrypted data using a common key;
a first communication unit configured to transmit, to the first other communication device, the encrypted data being encrypted using the common key;
a first common key update unit configured to update, after an update timing of the common key is reached, the common key by using an unencrypted stream of the encrypted data that starts to be transmitted by the first communication unit after the update timing of the common key; and
a control unit configured to control the encryption unit so that the encryption unit does not start the encryption of the stream and control the first communication unit so that the first communication unit does not start the transmission of the encrypted data, in a case where a time when the stream to be transmitted to the first other communication device is generated is within a predetermined period before and after the update timing, and
the first other communication device includes:
a second communication unit configured to receive, from the communication device, encrypted data obtained by encrypting a stream using the common key;
a decryption unit configured to decrypt the encrypted data received by the second communication unit into a stream using the common key; and
a second common key update unit configured to update, after the common key update timing is reached, the common key by using the stream obtained by decrypting the encrypted data, the encrypted data having started to be received by the second communication unit after the updating timing.

10. The communication system according to claim 9, wherein
the communication device further includes a first time synchronization unit configured to correct time in such a manner that a time lag between the first other communication device and the communication device falls within a predetermined error range,
the control unit sets the predetermined period as the predetermined error range, and
the first other communication device further includes a second time synchronization unit configured to correct time in such a manner that a time lag between the communication device and the first other communication device falls within a predetermined error range.

11. The communication system according to claim 9, further comprising a second other communication device configured to transmit a stream to the first other communication device, or receive a stream from the communication device, wherein
the communication device further includes a first time synchronization unit configured to correct time in such a manner that a time lag between the communication device and the first or the second other communication device falls within a predetermined error range,
the control unit sets the predetermined period to be twice the predetermined error range, and
the first other communication device further includes a second time synchronization unit configured to correct time in such a manner that a time lag between the first other communication device and one of the communication device and the second other communication device falls within a predetermined error range.

12. A communication method performed by a communication device, comprising:
performing an encryption process of encrypting a stream to be transmitted to a first other communication device into encrypted data using a common key;
performing a transmission process of transmitting, to the first other communication device, the encrypted data encrypted using the common key;
updating, after an update timing of the common key is reached, the common key using an unencrypted stream of the encrypted data started to be transmitted after the update timing; and
controlling the encryption process and the transmission process in such a manner that the encryption process and the transmission process are not started in a case where a time when the stream to be transmitted to the first other communication device is generated is within a predetermined period before and after the update timing.

13. The communication method according to claim 12, further comprising:
correcting time in such a manner that a time lag between the first other communication device and the communication device falls within a predetermined error range; and
setting the predetermined period as the predetermined error range.

14. The communication method according to claim 12, further comprising:
correcting time in such a manner that a time lag between the communication device and the first other communication device or a second other communication device falls within a predetermined error range, when there is the second other communication device configured to transmit a stream to the first other communication device or receive a stream from the communication device; and
setting the predetermined period to be twice the predetermined error range.
